(19) United States
(12) Patent Application Publication
(10) Pub. No.: US 2009/0047641 A1
(43) Pub. Date: Feb. 19, 2009

(54) Alphabet computer game

(76) Inventor: Y. Sabine Hayes, Raleigh, NC (US)

Correspondence Address: JAMES RAY & ASSOCIATES, 2640 PITCAIRN ROAD, MONROEVILLE, PA, 15146, US

(21) Appl. No.: 12/228,948

(22) Filed: Aug. 18, 2008

Related U.S. Application Data
(60) Provisional application No. 60/956,601, filed on Aug. 17, 2007.

(51) Int. Cl. G09B 17/00

(52) U.S. Cl. 434/159

(57) ABSTRACT

A method for testing the alphabetical order knowledge possessed by a person in combination with an electronic machine including a display member, a computational means, an electronic timer, a data storage device, a keyboard, a point-and-select input means, and a data bank of words on the data storage device, the method starting with the steps of the electronic machine selecting and displaying a word with simultaneous beginning of a timer. As instructed on the display means, the person commences entering letters from the selected word in alphabetical order into answer spaces provided on the display member. Upon completion, stopping of the timer by the electronic machine is followed immediately by assessing by a computational method of the correctness of the order of the letters entered into the answer area, then assigning and displaying a score based on elapsed time and correctness of the order.

### CROSS REFERENCE TO RELATED APPLICATION

This patent application is related to and claims priority from U.S. Provisional Patent Application Ser. Number 60/956,601 filed Aug. 17, 2007.

### FIELD OF THE INVENTION

The present invention relates, in general, to educational computer games and, more particularly, this invention relates to computer games to test and reinforce knowledge of alphabetical order.

### BACKGROUND OF THE INVENTION

Educational games are abundant in the prior art in numerous forms. Many of these have been played with cards or blocks, and some have pertained to helping learn or master the alphabet. Examples would be British patent 22,796 and U.S. Pat. No. 5,092,777. With the advent of computers and other electronic technology, some games moved to this format with player input via a keyboard, mouse, or bar-code wand. An example of the latter is provided in U.S. Pat. No. 4,457,719 which discloses an electronic learning aid using bar codes under words or pictures for indicating sequencing by alphabetical order. Certain aspects of building word-related computer games are disclosed in U.S. Pat. Nos. 5,456,607 and 6,755,657. One attribute of such games rarely mentioned in the prior art is that of assessing the speed at which the player obtains the desired result.

### SUMMARY OF THE INVENTION

The present invention provides a method for testing the alphabetical order knowledge possessed by a person in combination with an electronic machine including a display member, a computational means, an electronic timer, a data storage device, a keyboard, a point-and-select input means, and a data bank of words on the data storage device. The method starts with the steps of the player indicating readiness to start followed by the electronic machine selecting and displaying a word with simultaneous beginning of a timer. As instructed in the display member, the person begins entering letters from the selected word in alphabetical order into answer spaces provided on the display member. The player goes on continuing letter positioning until all letters of the selected word have been entered into the answer area. This activates stopping of the timer by the electronic machine followed immediately by assessing, done by a computational method, of the correctness of the order of the letters entered into the answer area, then assigning and displaying a score based on elapsed time and correctness of the answers.

In an alternative embodiment, the player is given the opportunity to correct mistakes until the entire order is correct, and scoring is then done by time to complete. In another alternative embodiment, the player is offered choices for the degree of difficulty.

### OBJECTS OF THE INVENTION

It is, therefore, one of the primary objects of the present invention to provide a computer based game that tests the player's skill at placing letters into alphabetical order.

Another object of the present invention is to provide an educational game which provides scoring on the basis of correctness and/or speed of attaining such.

Still another object of the present invention is to provide an educational alphabet game with varying levels of difficulty.

Yet another object of the present invention is to provide an educational game that can be enjoyed by children and adults.

In addition to the various objects and advantages of the present invention described with some degree of specificity above, it should be obvious that additional objects and advantages of the present invention will become more readily apparent to those persons who are skilled in the relevant art from the following more detailed description of the invention, particularly, when such description is taken in conjunction with the attached drawing figures and with the appended claims.

### BRIEF DESCRIPTION OF THE DRAWINGS

FIG. 1 is a block flow algorithm of an embodiment of the present invention.

FIG. 2 provides a frontal elevation view of a video display illustrating playing of the present invention.

FIG. 3 is a block flow algorithm of an alternative embodiment of the present invention.

FIG. 4 is a simplified block flow diagram illustrating an alternative embodiment of the present invention.

FIG. 5 is a block diagram illustrating a scoring method of the present invention.

### DETAILED DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

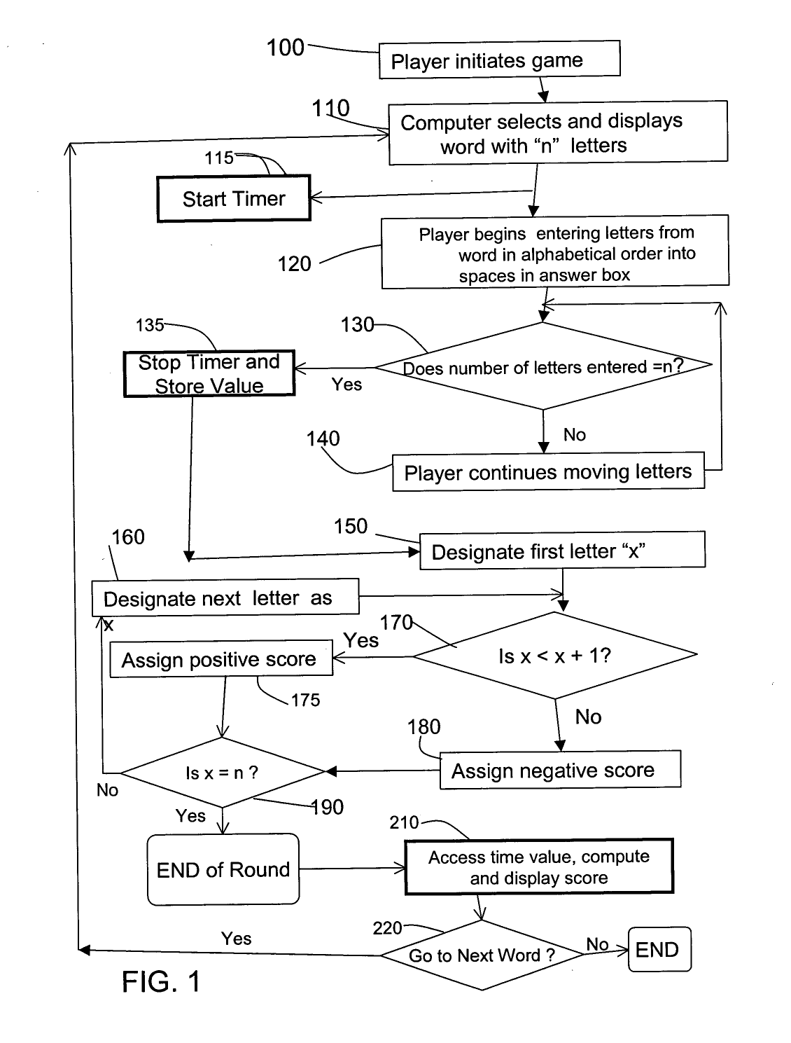

FIG. 1 provides a block flow algorithm illustrating an embodiment of the computed-based alphabet game. The software for the game has been installed on a conventional personal computer. At step 100, the player indicates readiness to begin playing the game. This triggers step 110 by the computer to select and display a word from the built-in data bank of words. Essentially simultaneously, the computer starts the timer, block 115, for evaluating the speed by which the playing person completes the task. At step 120, the player begins entering letters from the word into the answer box on the display beginning with the lowest one in the alphabet to the left and proceeding in that sequence until all the letters have been entered. The letters can be grabbed and moved to the answer box by clicking on or dragging with a point-and-select means, such as a display icon operable by a mouse, or by typing with the keyboard. The computer has assigned each letter a number identifier from 1 to 26 for later assessment of the correct order. When the number of letters entered into the answer box equals the number in the selected word, step 130, the computer stops the timer and saves that value in memory, step 135. At step 150, the computer begins assessment of the correctness of the player's answers beginning with the first letter to the left. As indicated above, the letters have the logical one to twenty-six number identification. This enables the computer, at step 170, to readily compare whether or not a letter is lower in the alphabet than the one immediately to its right. If it is, a positive score is given as indicated by block 175; otherwise, a negative or zero score is allocated as block 180 indicates. This assessment continues until the next to last letter is evaluated, box 190. The computer then uses the correct number of letter placements and the time value to compute and display a score, step 210. At step 220, the player is queried about continuing with another word or ending. If the answer is to go on, the process begins again at step 110.

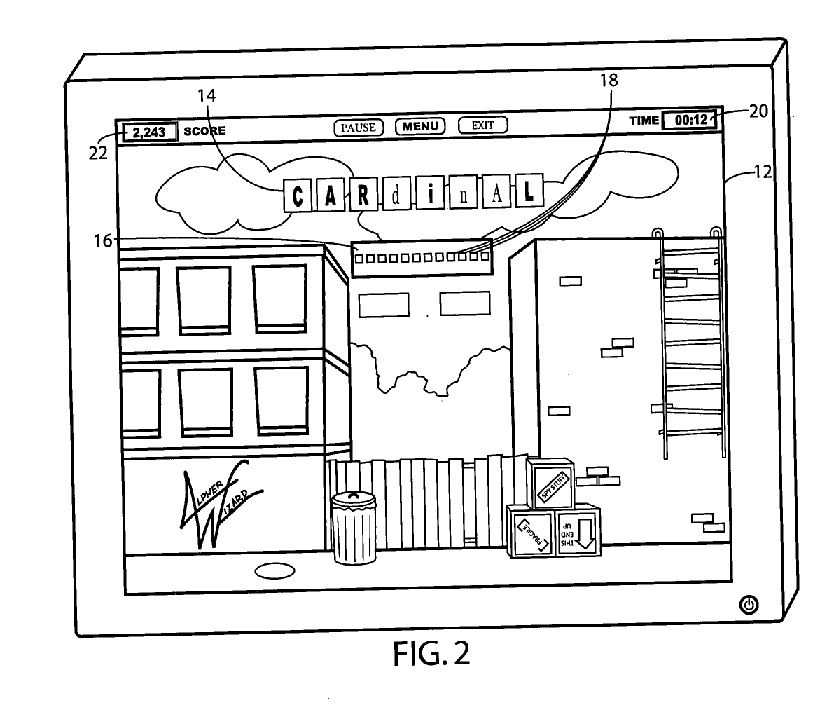

FIG. 2 presents a frontal elevation view of an exemplary display screen 12 connected to a computer for playing the game of the present invention. A word 14 is randomly selected and displayed to the player with individual letters 15. An answer box 16 is provided with a multiplicity of letter entry spaces 18. Starting with the left-most space 18 in box 16, the player types in or drags letters 15 from the word 14 into the boxes 18 in alphabetical order. Simultaneous with the word appearing or with the player's first action, a timer 20 begins keeping time in seconds. When all of the letters have been entered, the timer 20 stops. In one variation of the game, the player is offered a chance to correct mistakes, but time is lost doing so. The computer assesses the correctness of the player's answers and also uses the elapsed time to compute a score which is displayed in box 22. The score box can also be toggled to a running total based on a plurality of words played. The player can then indicate readiness to start with another word, and a new randomly selected word 14 is displayed. Play then continues as above.

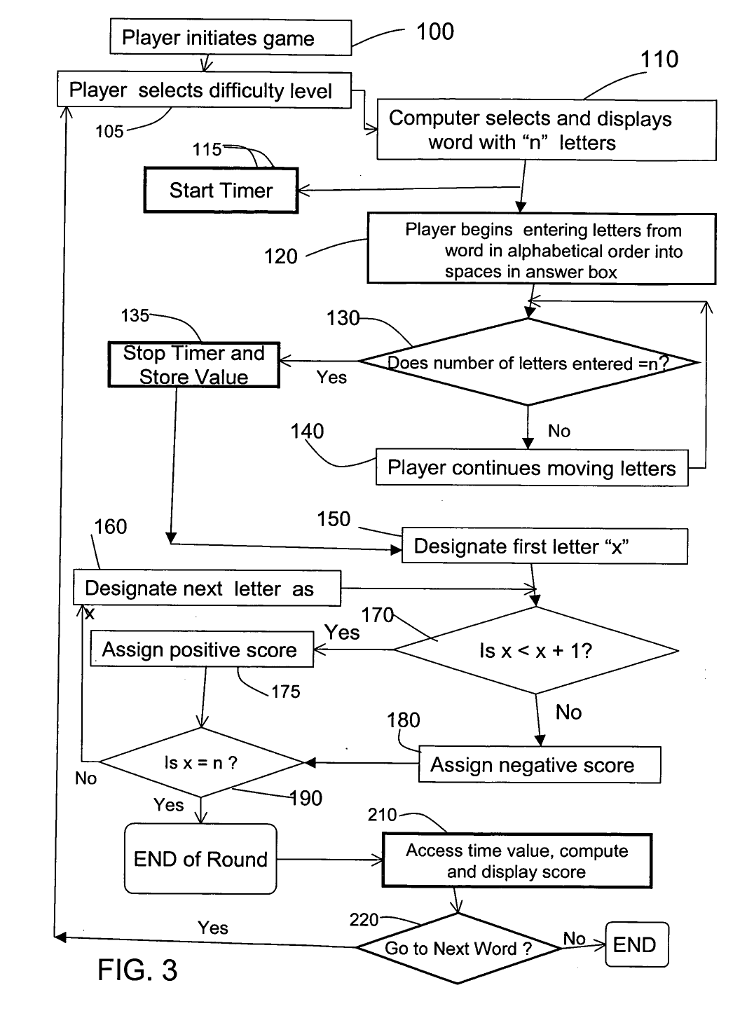

An alternative embodiment of the present invention is displayed as a block flow algorithm in FIG. 3. Prior to the displaying of the word at step 110, the playing person is directed to select a degree of difficulty for the word at step 105. Afterward, the process continues as described for FIG. 1.

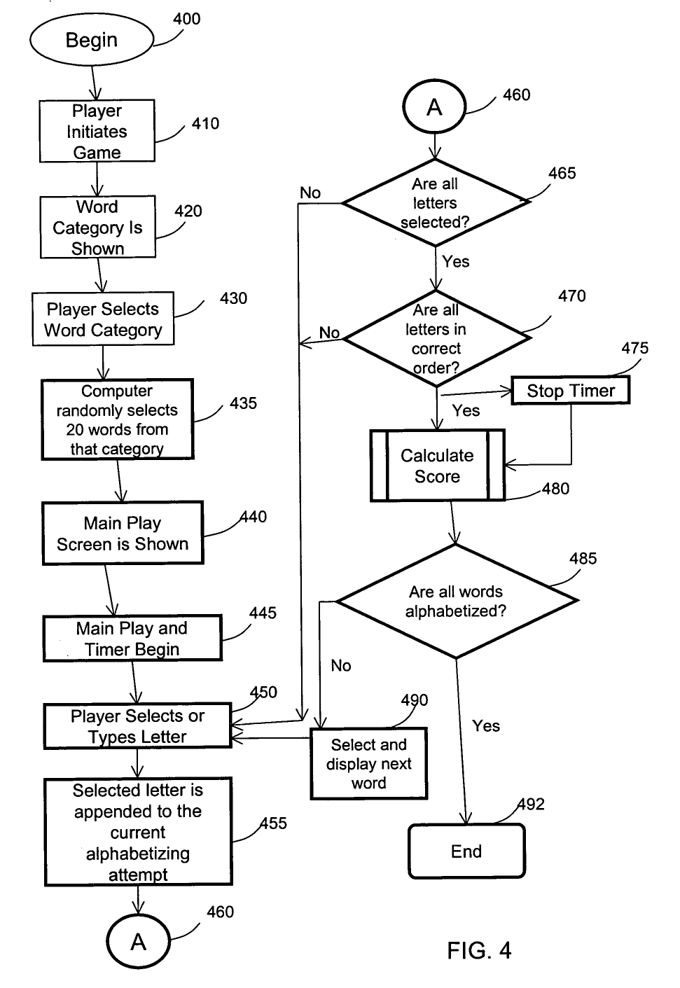

FIG. 4 provides a simplified block flow diagram of an alternative embodiment of the game play. After the player initiates the game at step 410, a word category is shown, step 420, and the player selects the desired word at step 430. Subsequently, at step 435, the computer or other electronic machine randomly selects 20 words out of that category from a built-in database. The main play of the game then get underway as the main play screen is shown, step 440, and then the timer starts and play begins at step 445. As indicated at step 450, the player then proceeds to select the letters in the displayed word in what they believe is alphabetical order. This can be done by dragging with the mouse or typing with the keyboard the letters into spaces in an answer box. Alternatively, the player can click on the letter with the mouse and that letter will be entered in the next box. The player can see the letters appear on the display device, step 455. The computer checks to see if all of the letters have been selected, step 465, then it assesses the correctness of the order, step 470. If correct, the timer stops, step 475, and the score for that word is calculated, step 480. If not correct, or letters still remain, the player is prompted to return to step 450 until all letters are placed in the correct order. After step 480, the computer checks at step 485 to see if additional words remain, and if so, the next word is displayed, step 490, and play resumes at step 450. After all words have been alphabetized, the game ends at step 492.

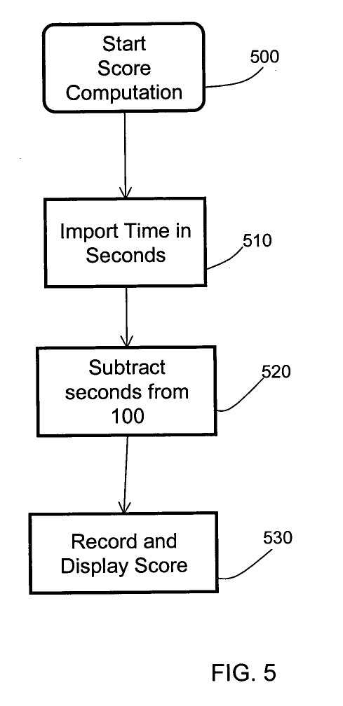

FIG. 5 depicts in flow diagram form one score keeping method of the present game invention. When all letters have been placed in correct order, score computation for that word begins at step 500 with importing of the elapsed time in seconds, step 510. The number of seconds is then subtracted from 100 at step 520. Then at step 530, the score for that word is stored and displayed. An alternative method is to provide one opportunity to arrange in alphabetical order, then scoring by correctness and speed by a point system.

While a presently preferred and various alternative embodiments of the present invention have been described in sufficient detail above to enable a person skilled in the relevant art to make and use the same, it should be obvious that various other adaptations and modifications can be envisioned by those persons skilled in such art without departing from either the spirit of the invention or the scope of the appended claims.

What is claimed is:

1. A method for testing the alphabetical order knowledge possessed by a person in combination with an electronic machine including a display member, a computational means, an electronic timer, a data storage device, a keyboard, a point-and-select input means, and a data bank of words on said data storage device, said method comprising the steps of:
a) starting of the game by said person being tested;
b) displaying a randomly selected word from said data bank on said display member;
c) beginning said electronic timer;
d) prompting said person to begin entering letters from said randomly selected word in alphabetical order into answer spaces provided on said display member;
e) entering by said person of letters from said selected word into spaces provided in an answer area on said display member;
f) continuing letter positioning by said person until all letters of said selected word have been entered into said answer area;
g) stopping of said electronic timer by said computational means;
h) assessing by said computational means correctness of order of said letters entered into said answer area;
i) assigning a score based on elapsed time and said correctness of order; and
j) displaying a point score on said display member.

2. The method for testing alphabetical knowledge, according to claim 1, which further includes a step of selecting a degree of difficulty for said randomly selected word.

3. The method for testing alphabetical knowledge, according to claim 1, which further includes using a personal computer as said electronic machine.

4. The method for testing alphabetical knowledge, according to claim 1, which further includes using a computer hard drive as said data storage device.

5. The method for testing alphabetical knowledge, according to claim 1, which further includes using a compact disk as said data storage device.

6. The method for testing alphabetical knowledge, according to claim 1, which further includes using an electronic mouse as said point-and-select means.

7. A method for testing the alphabetical order knowledge possessed by a person in combination with an electronic machine including a display member, a computational means, an electronic timer, a data storage device, a keyboard, a point-and-select input means, and a data bank of words on said data storage device, said method comprising the steps of:
a) starting of the game by said person being tested selecting a word category;
b) displaying a word from said word category stored in said data bank;
c) beginning said electronic timer;
d) prompting said person to begin entering letters from said randomly selected word in alphabetical order into answer spaces provided on said display member;
e) entering by said person letters from said selected word into spaces provided in an answer area on said display member;
f) continuing letter positioning by said person until all letters of said selected word have been entered into said answer area;
g) assessing, by said computational means, correctness of order of said letters entered into said answer area;
h) directing said person to correct improper order as needed;
i) repeating steps 7f) and 7g) as needed until correct order is attained;
j) stopping of said electronic timer by said computational means;
k) assigning a score for each said word based on elapsed time to arrange word letters in alphabetical order; and
l) displaying a point score on said display member.

8. The method for testing alphabetical knowledge, according to claim 7, which further includes using a computer hard drive as said data storage device.

9. The method for testing alphabetical knowledge, according to claim 7, which further includes using an electronic mouse as said point-and-select means.

10. The method for testing alphabetical knowledge, according to claim 7, which further includes using a compact disk as said data storage device.
